(19) United States
(12) Patent Application Publication
(10) Pub. No.: US 2008/0285504 A1
(43) Pub. Date: Nov. 20, 2008

(54) Multimode wireless network device, system and the method thereof

(75) Inventor: Yi-Jen Lin, Sijhih City (TW)

Correspondence Address: TROXELL LAW OFFICE PLLC, SUITE 1404, 5205 LEESBURG PIKE, FALLS CHURCH, VA, 22041, US

(73) Assignee: CAMEO COMMUNICATIONS, INC.

(21) Appl. No.: 11/798,502

(22) Filed: May 14, 2007

(51) Int. Cl. H04B 7/208; H04L 12/28; H04Q 7/00

(52) U.S. Cl. 370/319; 370/331; 370/401

(57) ABSTRACT

The present invention provides a multimode wireless network device, system and the method thereof. Particularly, a dual role of router and relay station is provided simultaneously in the multimode wireless network device; furthermore, dual communication modes, namely WiMAX and WiFi, are provided at the same time. The first multimode wireless network device located within the communication range of a WiMAX base station may establish a connection with the base station directly and transmit WiMAX wireless network signals. The second multimode wireless network device located outside of the communication range may establish a connection with the first multimode wireless network device so that the first multimode wireless network device becomes a relay station and may transmit wireless network signals between the second multimode wireless network device and the base station, thereby extending the communication range of the WiMAX base station.

### BACKGROUND OF INVENTION

1. Field of the Invention

The present invention relates to a multimode wireless network device, system and the method thereof; particularly, the present invention relates to a WiMAX wireless network device, system and the method thereof having a dual role of router and relay station in a WiMAX structure.

2. Description of the Prior Art

As the demands for portability and real time data transmission of the electronic devices continue to increase in the modern world, mobile communication function has become a requisite when an electronic device is purchased. With respect to a wireless network communication system, the combination of radio frequency and network technologies enables users to establish a connection with other network devices without physical lines thereto, and a wireless network enables the users to establish such connection to transmit data, thereby satisfying the demand for mobile network connections.

The conventional mobile Internet technology mainly includes GPRS (General Packet Radio Service), 3G (3rd Generation Communication System), WiFi (Wireless Fidelity) and WiMAX (Worldwide Interoperability for Microwave Access) etc. Since GPRS and 3G are established under the GSM structure, drawbacks such as relatively slow transmission speed and relatively high communication service fee still exist. In contrast, since WiFi and WiMAX are each established under the Ethernet network structure, they provide relatively faster network transmission speed and relatively lower communication service fees.

Under the WiFi structure in accordance with the IEEE 802.11b standard, short-range wireless transmission technology is provided within a communication range of approximately 300 feet; as a result, it is widely adopted in the wireless network devices in a WLAN (Wireless Local Area Network). The WiMAX structure is based on a series of IEEE 802.16 standards, such as IEEE 802.16-2004, IEEE 802.16e and IEEE 802.16j which is still being constructed, that can provide a communication range achieving a maximum range of 30 miles, and thus is usually applied at the WAN (Wide Area Network) level. Currently, WiFi and WiMAX are widely seen as complimentary instead of competing technologies and may replace GPRS and 3G and become the mainstream technologies in the mobile Internet field in the future.

In the conventional practice, WiMAX and WiFi are two independent wireless network systems. Refer to FIG. 1, which is a typical example of a conventional WiMAX (or WiFi) wireless network system. The conventional WiMAX wireless network system generally includes a plurality of WiMAX base stations 11, 12 so as to provide wireless network services. The magnitude of the wireless signals provided by each base station 11, 12 covers a communication range 111, 121, respectively. The WiMAX mobile Internet device 13 located within the communication range 111 of the base station 11 can establish a connection with the base station 11 and enjoy the mobile Internet service. If the WiMAX mobile Internet device 14 can receive signals from different base stations 11, 12, then the mobile Internet device 14 will automatically select the base station 12 with stronger and more stable signals to establish the connection. On the other hand, if a WiMAX mobile Internet device 15 is located outside of the communication ranges 111, 121 of the base stations 11, 12, then the mobile Internet device 15 will not be able to enjoy the mobile Internet service provided by the base stations 11, 12.

Therefore, in the conventional technology, WiMAX (or WiFi) system suppliers must install a large quantity of base stations so as to provide sufficient signal coverage and stable transmission quality. However, such installment will inevitably cause high infrastructural cost and indirectly hinder the spread of WiMAX (or WiFi). As a result, there's room for improvement.

### SUMMARY OF INVENTION

An object of the present invention is to provide a multimode wireless network device, system and the method thereof. The present invention provides a dual role of router and relay station simultaneously in a WiMAX wireless network device. Therefore, even if the multimode wireless network device of the present invention is located outside the communication range of a WiMAX base station, it can still relay signals through other multimode wireless network devices, thereby utilizing the mobile online service provided by the WiMAX base station, and thus achieve the goal of extending the communication range of the WiMAX base station.

Another object of the present invention is to provide a multimode wireless network device, system and the method thereof. The present invention supports dual communication modes, namely WiMAX and WiFi, simultaneously in a wireless network device. On the one hand, the multimode wireless network device of the present invention can utilize the WiMAX communication protocol to establish a connection with the WiMAX base station and transmit wireless network signals, while on the other hand the multimode wireless network device can further utilize the WiFi communication protocol to establish a connection with a terminal device and transmit wireless network signals, thereby having multiple advantages, such as the remote communication of WiMAX, as well as the security and low cost of WiFi.

In order to achieve the above mentioned objects, the present invention provides a multimode wireless network device, system and the method thereof. Particularly, a dual role of router and relay station is provided simultaneously in the multimode wireless network device; furthermore, dual communication modes, namely WiMAX and WiFi, are provided at the same time. The first multimode wireless network device located within the communication range of a WiMAX base station may establish a connection with the base station directly and transmit WiMAX wireless network signals. The second multimode wireless network device located outside of the communication range may establish a connection with the first multimode wireless network device so that the first multimode wireless network device becomes a relay station and may transmit wireless network signals between the second multimode wireless network device and the base station, thereby extending the communication range of the WiMAX base station.

In a preferred embodiment, the multimode wireless network device of the present invention further comprises: a WiMAX module, a WiFi module and a bridge module. The WiMAX module provides a WiMAX communication protocol to transmit wireless network signals with base stations. The WiFi module provides a WiFi communication protocol so as to establish a connection with a terminal device and transmit wireless network signals. The bridge module bridges between the WiMAX module and the WiFi module such that the wireless network signals between the two modules can be converted and transmitted, while supporting the WiMAX and WiFi communication protocols at the same time.

In order to achieve the above mentioned objects, the present invention also discloses a multimode wireless network method adapted in a multimode wireless network device. The method comprises the following steps:

(A) activating a connection function;

(B) checking if the multimode wireless network device is within a communication range of any base stations? If not, then proceed to step (C); if “Yes”, then perform the following steps: (B1) establishing a connection with the base station; and (B2) waiting for a connection request from a terminal device or other multimode wireless network devices;

(C) checking if other multimode wireless network devices exist within the communication range thereof? If yes, then proceed to step (D); if no, then perform the following step: (C1) reporting a connection failure; and

(D) establishing a connection with the other multimode wireless network device and making the other multimode wireless network device a relay station for a data transmission.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a typical structural view of a conventional WiMAX wireless network system;

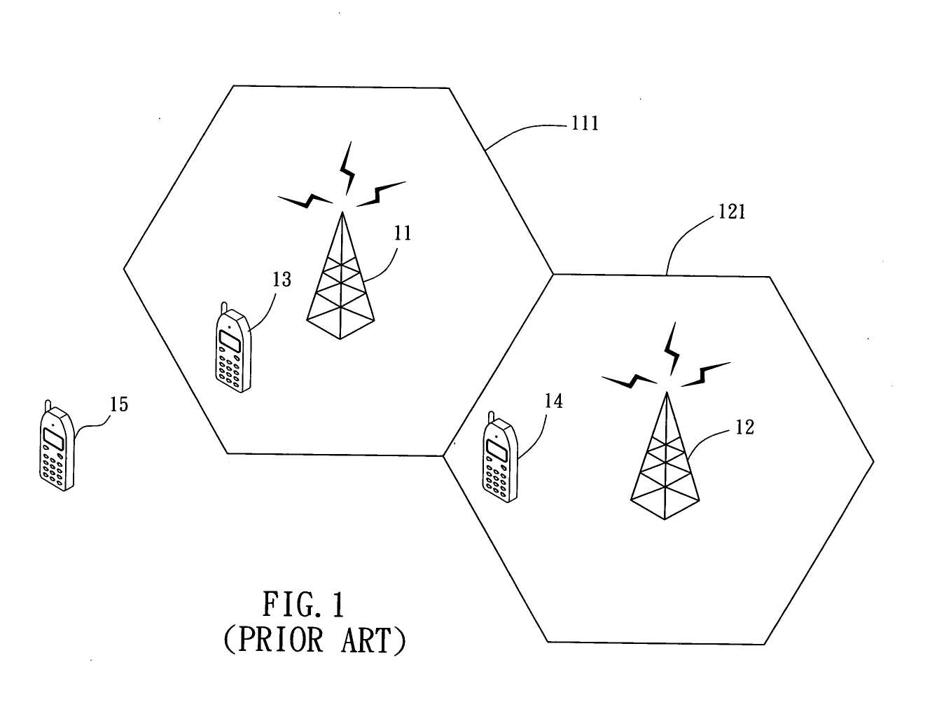

FIG. 2 is a structural view of an embodiment of the multimode wireless network system in accordance with the present invention;

FIG. 3 is a schematic view of the elements of an embodiment of the multimode wireless network device in accordance with the present invention;

FIG. 4 is a flow chart of an embodiment of the multimode wireless network method in accordance with the present invention.

### DETAILED DESCRIPTION OF THE EMBODIMENTS

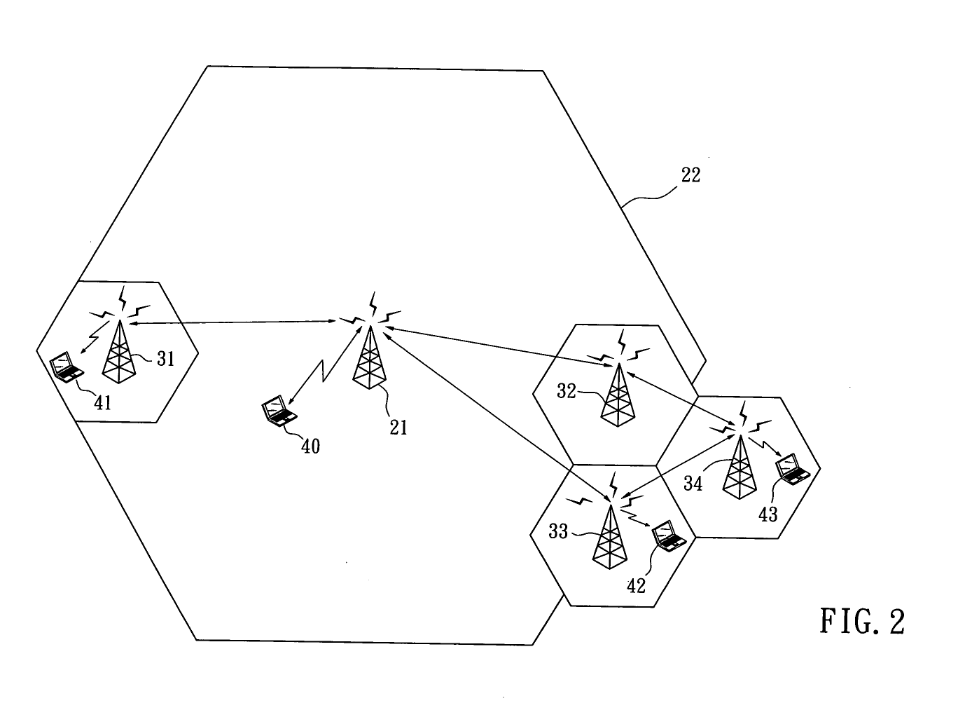

Refer to FIG. 2, which shows a structural view of an embodiment of the multimode wireless network system in accordance with the present invention. The multimode wireless network system of the present invention includes at least one base station 21, a plurality of multimode wireless network devices 31˜34 and a plurality of terminal devices 40˜43.

The base station 21 can be a WiMAX base station compliant with a WiMAX communication protocol so as to provide wireless mobile Internet services (also referred to as wireless network communication services) within a relatively wide communication range 22 (max. 30 miles).

In a preferred embodiment of the present invention, the plurality of multimode wireless network devices 31˜34 can simultaneously provide routing and relaying capabilities as well as supporting dual communication modes of WiMAX and WiFi at the same time. In general, the multimode wireless network devices 31˜34 of the present invention may preferably be, for example, wireless routers, wireless switches, wireless IP sharing devices, wireless access points; however, the multimode wireless network devices 31˜34 may also be terminal devices with a built-in WiMAX communication module. The multimode wireless network devices 31, 32, 33 (also referred to as the first multimode wireless network devices) located within the communication range 22 of the WiMAX base station 21 may establish a connection with the base station 21 directly, and perform WiMAX wireless network signal transmission, namely the WiMAX mobile Internet service provided by the base station 21. The multimode wireless network device 34 (also referred to as the second multimode wireless network device) located outside the communication range 22 may not establish a connection with the base station 21 directly. However, the multimode wireless network devices 31˜34 of the present invention are built in with a relay function, and thus the second multimode wireless network device 34 can establish a connection with the first multimode wireless network device 32 or 33, so that the first multimode wireless network device 32 or 33 becomes a relay station, thereby repeating the wireless communication signals between the second multimode wireless network device 34 and the base station 21.

In the present invention, the terminal devices 40˜43 refer to electronic devices capable of establishing a connection and transmitting wireless network signals with the base station 21, or the multimode wireless network devices 31˜34 of the present invention via a wireless communication method. For example, the terminal devices 40˜43 may be but not limited to be personal computers, laptops, smart phones, PDAs, gaming devices, wireless network cards, or other electronic devices with built-in or externally connected with a WiMAX or WiFi transmitter.

The terminal device 40 with the WiMAX communication capability located within the communication range 22 of the base station 21 may establish a connection with the base station 21 directly via the WiMAX communication protocol and utilizes the WiMAX mobile Internet service. The terminal device 41 with mere WiFi communication capability or the terminal device 42 closer to the multimode wireless network device 33 and thus capable of receiving more stable signals must first establish a connection with the multimode wireless network devices 31, 33 close by, and then transmit signals between the terminal devices 41, 42 and the base station 21 through the multimode wireless network devices 31, 33, respectively. In other words, the multimode wireless network devices 31˜34 of the present invention can provide routing capabilities, thereby allowing the plurality of terminal devices 41˜43 supporting WiMAX or WiFi communication functions to establish connections and utilizing the WiMAX mobile Internet service provided by the base station 21. Even for the terminal device 43 located outside the communication range 22 of the base station 21, due to the relaying capability provided by the multimode wireless network devices 31˜34 of the present invention, signals of the multimode wireless network device 34 can be relayed through other multimode wireless network device 32 or 33, thereby utilizing the WiMAX mobile Internet service provided by the base station 21. As a result, the multimode wireless network device and system of the present invention can surely achieve the goal of extending the communication range 22 of the WiMAX base station 21, so that system providers can install less base station 21 but still provide quality signal coverage and stable transmission, and thus decreasing the cost of basic infrastructure.

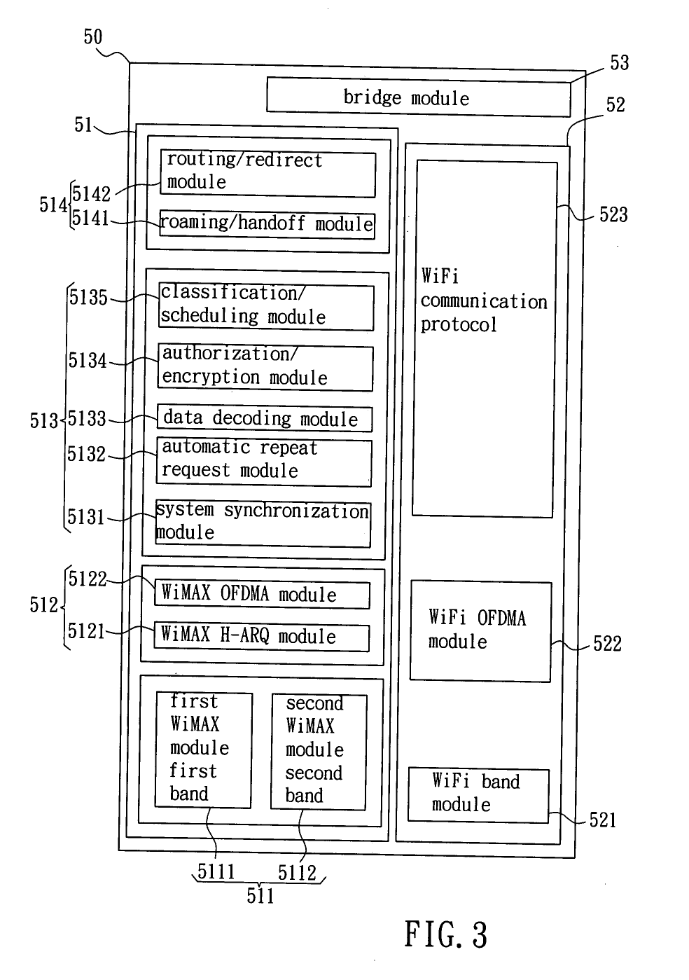

Refer to FIG. 3, which shows a schematic view of an embodiment of the elements of the multimode wireless network device 50 in accordance with the present invention. The multimode wireless network device 50 includes a WiMAX module 51, a WiFi module 52 and a bridge module 53. The WiMAX module 51 may provide wireless network signal transmission with the base stations, the terminal devices supporting the WiMAX communication protocol or other multimode wireless network devices utilizing the WiMAX communication protocol. The WiFi module 52 establishes a connection with the terminal devices supporting the WiFi communication protocol utilizing the WiFi communication protocol and performs wireless network signal transmission. The bridge module 53 provides a bridging function between the WiMAX module 51 and the WiFi module 52, so that the wireless network signals between the two modules can be converted and transmitted, while supporting the WiMAX and WiFi communication protocols at the same time.

The WiMAX module 51 further includes a WiMAX baseband module 511, a WiMAX repeat request multiplexing module 512, a WiMAX communication protocol module 513, and a WiMAX forwarding module 514.

The WiMAX baseband module 511 provides wireless communication within a predetermined frequency band. In this embodiment, the frequency band is based on the IEEE 802.16 standard. The WiMAX baseband module 511 further includes the first WiMAX band module 5111 and the second WiMAX band module 5112. The first WiMAX band module 5111 may provide WiMAX wireless communication in the frequency band between 3.4˜3.7 GHz under the international standard. For example, the current frequency band for WiMAX in the Taiwan region is set at 3.5 GHz. The second WiMAX band module 5112 performs WiMAX wireless communication in the frequency band between 2.5˜2.69 GHz under the U.S. standard. For example, the current frequency band for WiMAX in the U.S. region is set at 2.5 GHz.

The WiMAX repeat request multiplexing module 512 may perform debugging, repeat request and multiplexing to the transmitted signals. In the embodiment, the WiMAX repeat request multiplexing module 512 further includes a WiMAX Hybrid-Automatic Repeat Request (abbreviated as H-ARQ) module 5121 and a WiMAX orthogonal frequency division multiple access (abbreviated as OFDMA) module 5122. The WiMAX Hybrid-Automatic Repeat Request module 5121 may provide an automatic repeat request when transmitted data is detected with errors. The WiMAX orthogonal frequency division multiple access module 5122 may provide multiplexing function for analog signals, so that the multimode wireless network device 50 of the present invention may perform WiMAX wireless signal transmission with one or more terminal devices or other multimode wireless network devices simultaneously.

The WiMAX communication protocol module 513 may interpret and process transmitted signals that are compliant with the WiMAX communication protocol. In the embodiment, the WiMAX communication protocol module 513 further includes a system synchronization module 5131, an automatic repeat request (abbreviated as ARQ) module 5132, a data decoding module 5133, an authorization/encryption module 5134, and a classification/scheduling module 5135. The system synchronization module 5131 may provide time synchronization for wireless network signal transmission. The automatic repeat request module 5132 may provide an automatic repeat request when transmitted data is detected with errors. The data decoding module 5133 may interpret transmitted signals that are compliant with the WiMAX communication protocol; the content of the data in the transmitted signals may include but not limited to field data, such as DL-MAP, UL-MAP, DCD, and UCD. The authorization/encryption module 5134 may check for the authorization of transmitted signals as well as perform encryption for transmitted signals. The classification/scheduling module 5135 may classify data contained in the transmitted signals as well as perform scheduling.

The WiMAX forwarding module 514 may forward signals of the portable multimode wireless network device 50. In the embodiment, the WiMAX forwarding module 514 further includes a roaming/handoff module 5141 and a routing/redirect module 5142. The roaming/handoff module 5141 may determine which base station or other multimode wireless network device is to establish a connection to when the multimode wireless network device 50 is moved between different base stations or is covered by signals of other multimode wireless network devices. The routing/redirect module 5142 is used to perform the aforesaid routing and relaying functions as well as perform redirecting when the multimode wireless network device 50 changes the base station or other multimode wireless network device it is connected to.

In the present invention, the WiFi module 52 further includes a WiFi band module 521, a WiFi orthogonal frequency division multiple access (OFDM) baseband module 522, and a WiFi communication protocol module 523. The WiFi band module 521 may provide a WiFi frequency band that is compliant with the IEEE 802.11b standard. In other words, it is capable of performing WiFi wireless communication in the 2.4 GHz band. The WiFi orthogonal frequency division multiple access baseband module 522 may provide multiplexing for analog signals. So that the multimode wireless network device 50 of the present invention can perform WiFi wireless signal transmission with multiple terminal devices simultaneously. The WiFi communication protocol module 523 may interpret and process transmitted signals that are compliant with the WiFi communication protocol. Since the detailed structure of this portion of the WiFi communication protocol module 523 is not the technical feature of the present invention but belong to prior arts, it will not be described in details herein.

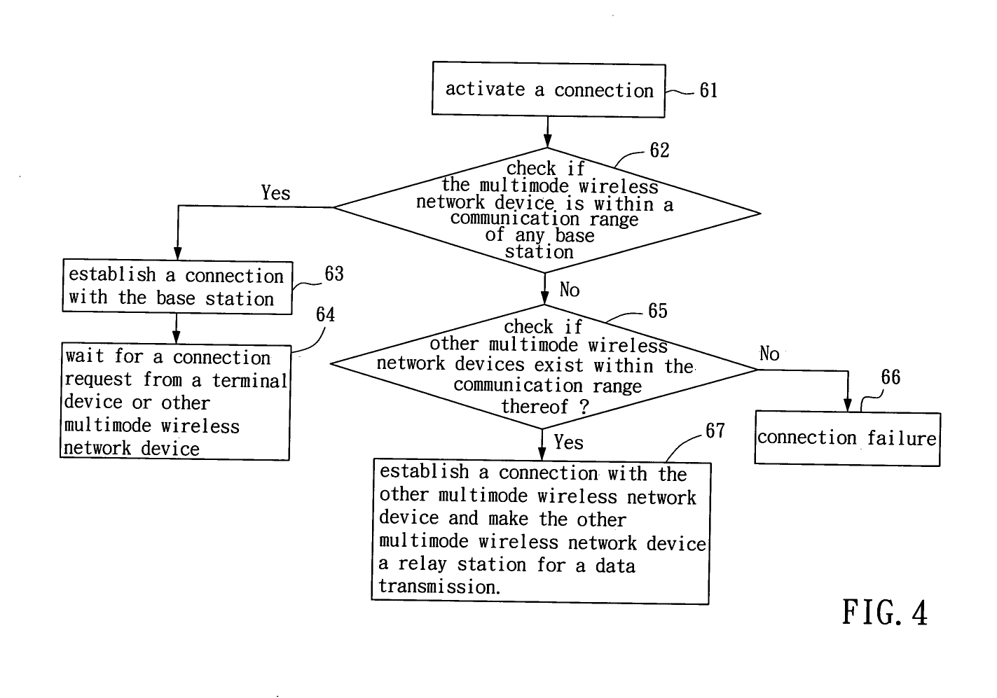

Refer to FIG. 4, which shows a flow chart of an embodiment of the multimode wireless network method in accordance with the present invention. The present method may be adapted in the multimode wireless network device of the present invention and may include the following steps:

Step 61: activate a connection function. Namely, activate the WiMAX and WiFi wireless communication functions as well as the dual function of routing and relaying of the multimode wireless network device in accordance with the present invention.

Step 62: check if it is within a communication range of any WiMAX base stations. In other words, check if signals of any WiMAX base stations can be received and at a level sufficient for communication. If not, then perform step 65; if the result is yes, then perform step 63.

Step 63: establish a connection with the WiMAX base station.

Step 64: wait for a connection request from a terminal device or other multimode wireless network devices. Enter a standby mode, and wait for a connection request from other terminal devices that support one of the two communication protocols, namely WiMAX or WiFi, or other multimode wireless network devices so as to provide mobile Internet service.

Step 65: check if other multimode wireless network devices supporting WiMAX exist within the communication range thereof and at a level sufficient for communication. If yes, then perform step 67; if the result is no, then perform step 66.

Step 66: report a connection failure.

Step 67: establish a connection with another multimode wireless network device, and make it a relay station and transmit data in the WiMAX communication protocol.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multimode wireless network system, comprising:
a base station providing a wireless network communication service within a communication range;
at least one first multimode wireless network device located within said communication range and connected with said base station so as to transmit wireless communication signals; and
at lease one second multimode wireless network device located outside said communication range and connected with said first multimode wireless network device such that said first multimode wireless network device becomes a relay station, transmitting wireless communication signals between said second multimode wireless network device and said base station.

2. The multimode wireless network system of claim 1, wherein said first and second multimode wireless network devices further include a routing function respectively, so as to provide a connection with at least one terminal device and to utilize said wireless network communication service provided by said base station.

3. The multimode wireless network system of claim 1, wherein said first and second multimode wireless network devices further include a WiMAX module respectively so as to utilize a WiMAX communication protocol to transmit wireless communication signals with said base station.

4. The multimode wireless network system of claim 3, wherein said WiMAX module further comprises:
a WiMAX baseband module for providing a wireless communication function in a predetermined band;
a WiMAX repeat request multiplexing module for performing functions of debugging, repeating request and multiplexing;
a WiMAX communication protocol module for interpreting and processing transmission signals compliant with said WiMAX communication protocol; and
a WiMAX forwarding module for providing a signal forwarding function to a portable multimode wireless network device.

5. The multimode wireless network system of claim 4, wherein said WiMAX baseband module further comprises:
a first WiMAX band module for providing a WiMAX wireless communication function within a frequency band between 3.4˜3.7 GHz; and
a second WiMAX band module for providing a WiMAX wireless communication function within a frequency band between 2.5˜2.69 GHz.

6. The multimode wireless network system of claim 4, wherein said WiMAX repeat request multiplexing module further comprises:
a WiMAX Hybrid-Automatic Repeat Request (H-ARQ) module for providing an automatic request to repeat a data transmission when transmitted data is detected with error; and
a WiMAX orthogonal frequency division multiple access (OFDMA) module for providing a multiplexing function for analog signals.

7. The multimode wireless network system of claim 4, wherein said WiMAX communication protocol module further comprises:
a system synchronization module for providing a time synchronization for wireless network transmission signals;
an automatic repeat request module for providing an automatic request to repeat a data transmission when transmitted data is detected with errors;
a data decoding module for interpreting transmitted signals compliant with said WiMAX communication protocol, said transmitted signals including but not limited to field data of DL-MAP, UL-MAP, DCD, and UCD;
an authorization/encryption module for checking authorization of transmitted signals as well as performing encryption for transmitted signals; and
a classification/scheduling module for classifying data contained in transmitted signals as well as scheduling.

8. The multimode wireless network system of claim 4, wherein said WiMAX forwarding module further comprises:
a roaming/handoff module for determining which base station or other multimode wireless network device is to establish a connection to, when said multimode wireless network device is moved between different base stations or is covered by signals of other multimode wireless network device; and
a routing/redirect module for redirecting transmitted signals when said multimode wireless network device changes base station or other multimode wireless network device connected thereto.

9. The multimode wireless network system of claim 1, wherein said first and second multimode wireless network devices further comprise a WiFi module respectively, so as to utilize a WiFi communication protocol to establish a connection with a terminal device and transmit wireless network signals.

10. The multimode wireless network system of claim 9, wherein said WiFi module further comprises:
a WiFi band module for providing a WiFi wireless communication in a frequency band of 2.4 GHz;
a WiFi orthogonal frequency division multiple access (OFDM) baseband module for providing a multiplexing function for analog signals; and
a WiFi communication protocol module for interpreting and processing transmitted signals compliant with said WiFi communication protocol.

11. The multimode wireless network system of claim 1, wherein said first and second multimode wireless network devices further respectively comprise:
a WiMAX module for providing a WiMAX communication protocol to transmit wireless network signals with base stations;
a WiFi module for providing a WiFi communication protocol so as to establish a connection with a terminal device and transmit wireless network signals; and
a bridge module for bridging between said WiMAX module and said WiFi module such that signals between said two modules can be converted and transmitted.

12. A multimode wireless network device for establishing a connecting with an external base station and terminal device and transmit wireless network signals, said multimode wireless network device comprising:
a WiMAX module for providing a WiMAX communication protocol to transmit wireless network signals with base stations;
a WiFi module for providing a WiFi communication protocol so as to establish a connection with a terminal device and transmit wireless network signals; and
a bridge module for bridging between said WiMAX module and said WiFi module such that signals between said two modules can be converted and transmitted

13. The multimode wireless network device of claim 12, wherein said WiMAX module further comprises:
a WiMAX baseband module for providing a wireless communication function in a predetermined band;
a WiMAX repeat request multiplexing module for performing functions of debugging, repeating request and multiplexing;
a WiMAX communication protocol module for interpreting and processing transmission signals compliant with said WiMAX communication protocol; and
a WiMAX forwarding module for providing a signal forwarding function to a portable multimode wireless network device.

14. The multimode wireless network device of claim 12, wherein said WiFi module further comprises:
a WiFi band module for providing a WiFi wireless communication in a frequency band of 2.4 GHz;
a WiFi orthogonal frequency division multiple access (OFDM) baseband module for providing a multiplexing function for analog signals; and
a WiFi communication protocol module for interpreting and processing transmitted signals compliant with said WiFi communication protocol.

15. A multimode wireless network method adapted in a multimode wireless network device, said method comprising the following steps:
(A) activating a connection function;
(B) checking if said multimode wireless network device is within a communication range of any base stations? If not, then proceed to step (C);
(C) checking if other multimode wireless network devices exist within said communication range thereof? If yes, then proceed to step (D); and
(D) establishing a connection with said other multimode wireless network device and making said other multimode wireless network device a relay station for a data transmission.

16. The multimode wireless network method of claim 15, wherein when a result of step (B) is yes, then perform the following steps:
(B1) establishing a connection with said base station; and
(B2) waiting for a connection request from a terminal device or other multimode wireless network devices.

17. The multimode wireless network method of claim 16, wherein when a result of step (C) is no, then perform the following steps:
(C1) reporting a connection failure.

18. The multimode wireless network method of claim 15, wherein said multimode wireless network devices further comprise:
a WiMAX module for providing a WiMAX communication protocol to transmit wireless network signals with base stations;
a WiFi module for providing a WiFi communication protocol so as to establish a connection with a terminal device and transmit wireless network signals; and
a bridge module for bridging between said WiMAX module and said WiFi module such that signals between said two modules can be converted and transmitted.

19. The multimode wireless network method of claim 18, wherein said WiMAX module further comprises:
a WiMAX baseband module for providing a wireless communication function in a predetermined band;
a WiMAX repeat request multiplexing module for performing functions of debugging, repeating request and multiplexing;
a WiMAX communication protocol module for interpreting and processing transmission signals compliant with said WiMAX communication protocol; and
a WiMAX forwarding module for providing a signal forwarding function to a portable multimode wireless network device.

20. The multimode wireless network method of claim 18, wherein said WiFi module further comprises:
a WiFi band module for providing a WiFi wireless communication in a frequency band of 2.4 GHz;
a WiFi orthogonal frequency division multiple access (OFDM) baseband module for providing a multiplexing function for analog signals; and
a WiFi communication protocol module for interpreting and processing transmitted signals compliant with said WiFi communication protocol.
